(19) United States
(12) Patent Application Publication
(10) Pub. No.: US 2024/0111776 A1
(43) Pub. Date: Apr. 4, 2024

(54) System and Methods for Monitoring and Quantifying Influential Effect of Social Media Accounts

(71) Applicant: StratInt Research, Laguna Hills, CA (US)

(72) Inventor: Lusine Kodagolian, Laguna Hills, CA (US)

(73) Assignee: StratInt Research, Laguna Hills, CA (US)

(21) Appl. No.: 17/959,154

(22) Filed: Oct. 3, 2022

(51) Int. Cl. G06F 16/2457; G06Q 50/00

(52) U.S. Cl. CPC G06F 16/24578; G06Q 50/01

(57) ABSTRACT

An influence quantification system and associated methods are disclosed for monitoring and quantifying a real-time influential effect of an at least one social media account hosted on an at least one social media platform. In at least one embodiment, a computing device is configured for receiving and processing data related to the at least one social media account. An influencer record is associated with each of the at least one social media account, with each influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account.

### RELATED APPLICATIONS

Not applicable.

### Background

The subject of this patent application relates generally to social media, and more particularly to a system and associated methods for monitoring and quantifying the influential effect of social media accounts.

Applicant(s) hereby incorporate herein by reference any and all patents and published patent applications cited or referred to in this application.

By way of background, social media influencers (or “influencers” for short) are entities (typically individuals, but sometimes groups or organizations) who have acquired or developed fame and notoriety through their activities via the Internet and social media platforms (such as Twitch, Instagram, YouTube, Snapchat, Discord, Twitter, Facebook, Reddit, LinkedIn and TikTok, for example), which has helped them increase their outreach to a global audience. Influencers often function as lifestyle or subject matter gurus who promote a particular lifestyle, attitude or opinion. In this role, they can be a significant source of influence upon the general public for trends in fashion, cooking, technology, traveling, video games, movies, politics, music, sports, entertainment, etc. As such, influencers are often recruited and compensated by companies to help advertise products and services to the influencers' fans and followers on their various social media platforms. Unfortunately, the authority and credibility of such influencers, with respect to the various topics and positions they might actively promote, is oftentimes presumed by the general public (or at least the individuals who “follow” said influencers) simply by virtue of said influencers being “celebrities” in the eyes of their followers. As a result, individuals who blindly follow an influencer's guidance on a particular topic, under the potentially mistaken belief of the influencer being an expert on that topic, run the risk of being negatively impacted by that guidance. For that same reason, companies seeking influencers to help promote their products or services desire to find the most relevant and knowledgeable influencers in their space. Thus, there is a growing need for a system capable of providing reliable, quantitative information on the current influential effectiveness of a given influencer with respect to a given topic on which the influencer has posted about.

Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing an influence quantification system and associated methods for monitoring and quantifying a real-time influential effect of an at least one social media account hosted on an at least one social media platform. In at least one embodiment, a central computing system is configured for receiving and processing data related to the at least one social media account. An at least one influencer record is associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account. Upon a user of the computing system desiring to quantify the real-time influential effect of a one of the at least one social media account via a computing device in communication with the computing system, the computing system is configured for: (a) obtaining an at least one analysis parameter from said user, said at least one analysis parameter comprising at least one of a comparison account, a topic, a keyword, or a date range; (b) obtaining the follower count associated with said social media account; (c) calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted; (d) obtaining the post count associated with said social media account; (e) calculating a normalized post z-score for said social media account using the formula z=(x−μ)/σ, where x is the post count associated with said social media account, μ is a population mean of posts on the social media platform where said social media account is hosted, and a is a population standard deviation of posts on the social media platform where said social media account is hosted; (f) calculating the engagement rate for said social media account; (g) calculating a normalized engagement z-score using the formula z=(x−μ)/σ, where x is the engagement rate for said social media account, μ is a population mean of engagement rates across the social media platform where said social media account is hosted, and a is a population standard deviation of engagement rates on the social media platform where said social media account is hosted; and (h) calculating the influencer score associated with said social media account by adding each of the follower z-score, post z-score and engagement z-score associated with said social media account together. Thus, in at least one embodiment, the higher the influencer score is for a given social media account, the greater the influential effect said social media account has on other social media accounts on the social media platform where said social media account is hosted.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a simplified schematic view of an exemplary influence quantification system, in accordance with at least one embodiment;

FIG. 2 is an architecture diagram of an exemplary influencer record, in accordance with at least one embodiment; and

FIG. 3 is a flow diagram of an exemplary method for dynamically calculating an influencer score for a given social media account, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

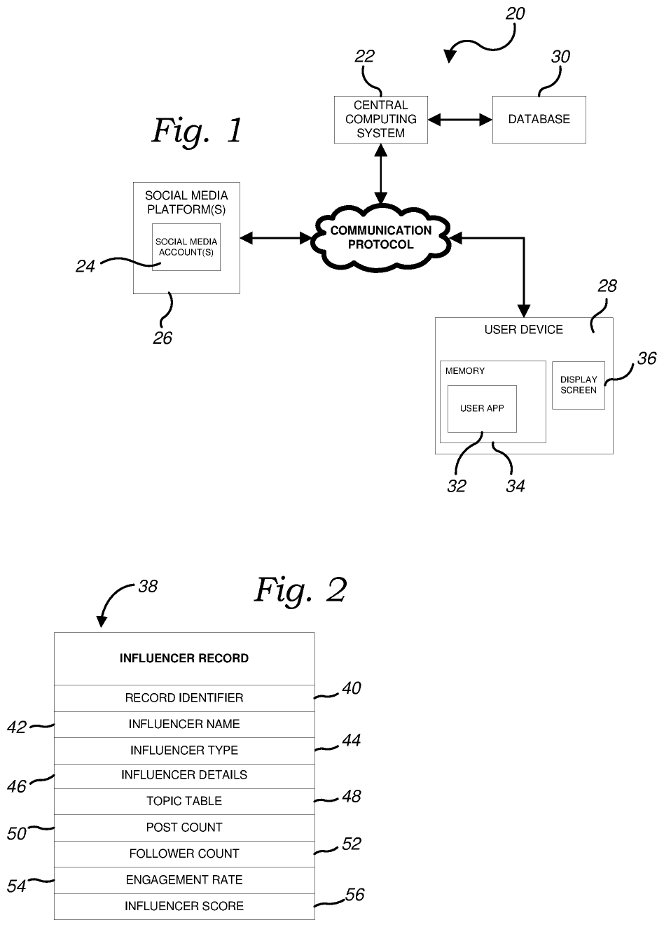

Turning now to FIG. 1, there is shown a simplified schematic view of an exemplary influence quantification system 20 configured for automatically monitoring and quantifying the influential effect of social media accounts, in accordance with at least one embodiment. At the outset, it should be noted that the term “social media account” as used herein is intended to mean an account on an interactive digital platform that facilitates the creation and sharing of digital content (e.g., text, photos, videos, etc.) containing information, ideas, interests, and other forms of expression through virtual communities and networks. Examples of social media accounts include (but are in no way limited to) accounts on Twitch, Instagram, YouTube, Snapchat, Discord, Twitter, Facebook, Reddit, LinkedIn and TikTok.

With continued reference to FIG. 1, in at least one embodiment, the system 20 provides a central computing system 22 configured for receiving and processing data related to an at least one social media account 24 hosted on an at least one social media platform 26. An at least one user device 28 is in selective communication with the computing system 22, as discussed further below. Additionally, in at least one embodiment, an at least one database 30 is in communication with the computing system 22 and configured for selectively storing said data related to each of the at least one social media account 24. In at least one embodiment, the computing system 22 and database 30 are one and the same—as such, it is intended that those terms as used herein are to be interchangeable with one another. In at least one embodiment, the computing system 22 and database 30 are omitted, such that the system 20 and associated methods described herein are implemented solely through the at least one user device 28—thus, any methods or functionality described herein as being carried out by the computing system 22 or database 30 may, in at least one embodiment, also be carried out by the at least one user device 28, regardless of whether such embodiments nevertheless incorporate the computing system 22 and/or database 30. In at least one embodiment, the computing system 22 is also in selective communication with the at least one social media platform 26 on which the at least one social media account 24 is registered and hosted, as discussed further below.

At the outset, it should be noted that communication between each of the computing system 22, at least one user device 28, at least one database 30, and at least one social media platform 26 may be achieved using any wired- or wireless-based communication protocol (or combination of protocols) now known or later developed. As such, the present invention should not be read as being limited to any one particular type of communication protocol, even though certain exemplary protocols may be mentioned herein for illustrative purposes. Similarly, in at least one embodiment, communications between each of the computing system 22, at least one user device 28, at least one database 30, and at least one social media platform 26 may be encrypted using any encryption method (or combination of methods) now known or later developed. It should also be noted that the term “user device” is intended to include any type of computing or electronic device, now known or later developed, capable of communicating with the computing system 22 and carrying out the functionality described herein—such as desktop computers, browser extensions, mobile phones, smartphones, laptop computers, tablet computers, personal data assistants, gaming devices, wearable devices, etc. As such, the present invention should not be read as being limited to use with any one particular type of computing or electronic device, even though certain exemplary devices may be mentioned or shown herein for illustrative purposes.

With continued reference to FIG. 1, in the exemplary embodiment, each of the computing system 22, at least one user device 28, and at least one database 30 contains the hardware and software necessary to carry out the exemplary methods for administering the influence quantification system 20, as described herein. Furthermore, in at least one embodiment, the computing system 22 comprises a plurality of computing devices selectively working in concert with one another to carry out the exemplary methods for administering the influence quantification system 20, as described herein. In at least one embodiment, the at least one user device 28 provides a user application 32 residing locally in memory 34 on the user device 28 (either as a standalone application or as a browser extension for an existing Internet browser on the user device 28), the user application 32 being configured for selectively communicating with the computing system 22, as discussed further below. It should be noted that the term “memory” is intended to include any type of electronic storage medium (or combination of storage mediums) now known or later developed, such as local hard drives, RAM, flash memory, secure digital (“SD”) cards, external storage devices, network or cloud storage devices, integrated circuits, etc. Additionally, in at least one embodiment, each of the at least one user device 28 is in the possession of a user who is desirous of utilizing the system 20 to automatically monitor and quantify the influential effect of an at least one social media account 24.

Furthermore, the various components of the at least one user device 28 may reside on a single computing and/or electronic device, or may separately reside on two or more computing and/or electronic devices in communication with one another. In at least one alternate embodiment, the functionality provided by the user application 32 resides remotely in memory on the computing system 22 and/or database 30, with the at least one user device 28 capable of accessing said functionality via an online portal hosted by (or at least in communication with) the computing system 22 and/or database 30, either in addition to or in lieu of the user application 32 residing locally in memory 34 on the at least one user device 28. It should be noted that, for simplicity purposes, the functionality provided by the user application 32 will be described herein as such—even though certain embodiments may provide said functionality through an online portal. It should also be noted that, for simplicity purposes, when discussing functionality and the various methods that may be carried out by the system 20 herein, the terms “user device” and “user application” are intended to be interchangeable. With continued reference to FIG. 1, in at least one embodiment, the at least one user device 28 provides an at least one display screen 36 for providing an at least one graphical user interface to assist the associated user in possession of said user device 28 to access and utilize the various functions provided by the system 20.

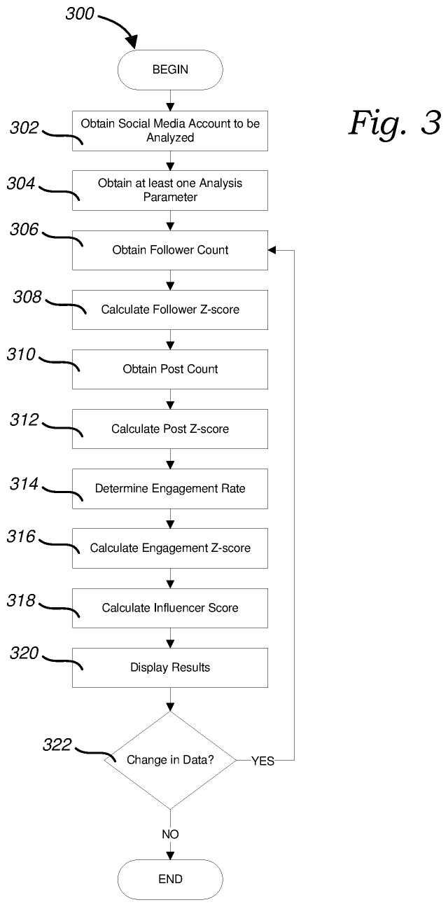

In at least one embodiment, as illustrated in the architecture diagram of FIG. 2, the computing system 22—or the at least one database 30—stores and manages an influencer record 38 for each social media account 24 to be monitored by the system 20, with each influencer record 38 containing various details related to the social media account 24. In at least one embodiment, each influencer record 38 contains at least one of a unique record identifier 40, an influencer name 42 associated with the social media account 24, an influencer type 44 containing an at least one category label corresponding to the social media account 24 (e.g., “journalist,” “politician,” “physician,” “fitness instructor,” “attorney,” “retailer,” etc.), additional influencer details 46 associated with the social media account 24 (e.g., influencer bio, tags associated with the social media account 24, notes associated with the social media account 24, etc.), a topic table 48 containing details related to any topics on which the associated social media account 24 has posted about, a post count 50 containing a numerical value corresponding to a quantity of discrete content posts made by the associated social media account 24, a follower count 52 containing a numerical value corresponding to a quantity of followers of the associated social media account 24, a numerical engagement rate 54 as described further below, and an influencer score 56 containing a numerical value corresponding to the relative effectiveness of the associated social media account 24 as dynamically calculated by the system 20 and discussed further below. It should be noted that while the term “table” is used herein to describe certain exemplary data structures, in at least one embodiment, any other suitable data type or data structure, or combinations thereof, now known or later developed, capable of storing the appropriate data, may be substituted. Thus, the present invention should not be read as being so limited. It should also be noted that the methods by which the computing system 22 collects the various above-mentioned details related to the social media account 24 may involve the use of an application programming interface (“API”) installed within the social media platform 26 associated with the social media account 24, or the use of web scraping tools, or any other tool, method or technique now known or later developed.

In at least one embodiment, as illustrated in the flow diagram of FIG. 3, through the user application 32 residing either locally in memory 34 on the at least one user device 28 or remotely on the computing system 22 and/or database 30, the method of dynamically calculating the influencer score 56 for a given social media account 24 entails the steps of a user first specifying the social media account 24 to be analyzed (302). In at least one such embodiment, the user provides the computing system 22 with the influencer name 42 associated with the social media account 24. In at least one embodiment, the user is able to further specify an at least one analysis parameter against which the social media account 24 is to be scored (304), should the user desire to obtain an influencer score 56 for the social media account 24 that is relative to the at least one analysis parameter. For example, in at least one such embodiment, the at least one analysis parameter is an at least one comparison account (i.e., a different social media account 24 that is unrelated to the social media account 24 to be analyzed), such that the resulting influencer score 56 calculated by the computing system 22 is relative to the at least one comparison account. As another example, in at least one such embodiment, the at least one analysis parameter is an at least one topic or keyword, such that the resulting influencer score 56 calculated by the computing system 22 is relative to the at least one topic or keyword. As yet another example, in at least one such embodiment, the at least one analysis parameter is a date range, such that the resulting influencer score 56 calculated by the computing system 22 is relative to the date range. In still further embodiments, any other types of analysis parameters now known or later developed—including but not limited to groups of social media accounts 24, number of followers, etc.—may be utilized.

In at least one embodiment, the computing system 22 next obtains the follower count 52 associated with the social media account 24 (306) (for example, by accessing the follower count 52 stored in the associated influencer record 38 or obtaining the follower count 52 directly from the associated social media platform 26) and calculates a normalized follower z-score (308) using the formula z=(x−μ)/σ, where x is the follower count 52, μ is a population mean of users (i.e., social media accounts) on the associated social media platform 26 (i.e., the average number of followers for social media accounts 24 on the associated social media platform 26), and σ is a population standard deviation of users on the associated social media platform 26. In at least one embodiment, where the user has specified an at least one analysis parameter, the population mean and population standard deviation are calculated based on the subset of users on the associated social media platform 26 that satisfy the at least one analysis parameter. For example, in at least one embodiment, where the user has specified at least one comparison account, the population mean and population standard deviation are calculated based on the quantity of users following the at least one comparison account rather than all users on the associated social media platform 26. As another example, in at least one embodiment, where the user has specified at least one topic, the population mean and population standard deviation are calculated based on the quantity of users following or otherwise interacting with content related to the at least one topic rather than all users on the associated social media platform 26. As yet another example, in at least one further embodiment, where the user has specified at least one comparison account and at least one topic, the population mean and population standard deviation are calculated based on the quantity of followers of the at least one comparison account who are following or otherwise interacting with content related to the at least one topic.

In at least one embodiment, the computing system 22 also obtains the post count 50 associated with the social media account 24 (310) (for example, by accessing the post count 50 stored in the associated influencer record 38 or obtaining the post count 50 directly from the associated social media platform 26) and calculates a normalized post z-score (312) using the formula z=(x−μ)/σ, where x is the post count 50, μ is a population mean of posts on the associated social media platform 26 (i.e., the average number of posts by social media accounts 24 on the associated social media platform 26), and σ is a population standard deviation of posts on the associated social media platform 26. In at least one embodiment, where the user has specified an at least one analysis parameter, the post count 50, population mean and population standard deviation are calculated based on the subset of posts on the associated social media platform 26 that satisfy the at least one analysis parameter. For example, in at least one embodiment, where the user has specified at least one comparison account, the population mean and population standard deviation are calculated based on the quantity of posts by the at least one comparison account rather than all social media accounts 24 on the associated social media platform 26. As another example, in at least one embodiment, where the user has specified at least one topic, the post count 50, population mean and population standard deviation are calculated based on the quantity of posts by social media accounts 24 containing content related to the at least one topic rather than all posts on the associated social media platform 26. As yet another example, in at least one further embodiment, where the user has specified at least one comparison account and at least one topic, the population mean and population standard deviation are calculated based on the quantity of posts by the at least one comparison account containing content related to the at least one topic.

In at least one embodiment, the computing system 22 obtains the engagement rate 54 associated with the social media account 24 (314) (for example, by accessing the engagement rate 54 stored in the associated influencer record 38 or calculating the engagement rate 54 in real-time). In at least one embodiment, calculating the engagement rate 54 entails dividing the total number of relevant content interactions (i.e., likes, reactions, shares, comments, etc.) received by the associated social media account 24 by the follower count 52 of the associated social media account 24, and multiplying the resulting quotient by 100. In at least one alternate embodiment, calculating the engagement rate 54 entails dividing the total number of content interactions received by the associated social media account 24 by an estimated total reach of the content posts made by the associated social media account 24. In at least one such embodiment, the total reach is calculated by multiplying the post count 50 associated with the social media account 24 by a pre-defined percentage of the follower count 52 associated with the social media account 24. For example, in at least one embodiment, the pre-defined percentage is 20%; however, in further embodiments, the pre-defined percentage may be any other percentage between 0% and 100%. In at least one further alternate embodiment, calculating the engagement rate 54 entails multiplying the total number of relevant content interactions received by the associated social media account 24 by a pre-defined value, such as 5 for example. In at least one embodiment, where the user has specified an at least one analysis parameter, the engagement rate 54 associated with the social media account 24 is calculated based on the subset of content posts by the associated social media account 24 that satisfy the at least one analysis parameter.

In at least one embodiment, the computing system 22 next calculates a normalized engagement z-score (316) using the formula z=(x−μ)/σ, where x is the engagement rate 54, μ is the population mean of engagement rates 54 across the associated social media platform 26 (i.e., the average engagement rate 54 for social media accounts 24 on the associated social media platform 26), and σ is the population standard deviation of engagement rates 54 on the associated social media platform 26. In at least one embodiment, where the user has specified an at least one analysis parameter, the population mean and population standard deviation are calculated based on the subset of engagement rates 54 across the associated social media platform 26 that satisfy the at least one analysis parameter. For example, in at least one embodiment, where the user has specified at least one comparison account, the population mean and population standard deviation are calculated based on the engagement rate 54 of the at least one comparison account rather than all social media accounts 24 on the associated social media platform 26. As another example, in at least one embodiment, where the user has specified at least one topic, the population mean and population standard deviation are calculated based on the engagement rates 54 for posts by social media accounts 24 containing content related to the at least one topic rather than all posts on the associated social media platform 26. As yet another example, in at least one further embodiment, where the user has specified at least one comparison account and at least one topic, the population mean and population standard deviation are calculated based on the engagement rates 54 for posts by the at least one comparison account containing content related to the at least one topic.

In at least one embodiment, upon calculating each of the follower z-score, post z-score and engagement z-score, the computing system 22 calculates the influencer score 56 associated with the social media account 24 by adding each of the follower z-score, post z-score and engagement z-score together (318). In at least one embodiment, the influencer score 56 is then provided to the user via a user interface as displayed on the user device 28 (320). Thus, in at least one embodiment, the higher the follower z-score, post z-score and engagement z-score for a given social media account 24, the higher the corresponding influencer score 56. In other words, the influencer score 56 has a direct correlation with the influential effect (i.e., authority and trustworthiness) of the associated social media account 24—either in connection with the at least one specified analysis parameter or generally (if no analysis parameters are specified). Thus, in at least one such embodiment, the influencer score 56 is similar to a credit score in that it provides a standardized, relative and absolute numerical score based on the influential effect of the associated social media account 24 (capable of dynamically changing based on the at least one analysis parameter selected by the user), which the user may then rely upon before deciding whether to trust the content provided by the social media account 24.

In at least one embodiment, this process may be automatically repeated by the computing system 22 periodically and/or upon the data contained in the at least one influencer record 38 being modified (322) so as to maintain an accurate, real-time influencer score 56 for each social media account 24 and/or analysis parameter.

Aspects of the present specification may also be described as the following embodiments:

1. A method for monitoring and quantifying a real-time influential effect of an at least one social media account hosted on an at least one social media platform, the method comprising the steps of: implementing a central computing system configured for receiving and processing data related to the at least one social media account; establishing, via the computing system, an at least one influencer record associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account; and upon a user of the computing system desiring to quantify the real-time influential effect of a one of the at least one social media account via a computing device in communication with the computing system: (a) the computing system obtaining an at least one analysis parameter from said user, said at least one analysis parameter comprising at least one of a comparison account, a topic, a keyword, or a date range; (b) the computing system obtaining the follower count associated with said social media account; (c) the computing system calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted; (d) the computing system obtaining the post count associated with said social media account; (e) the computing system calculating a normalized post z-score for said social media account using the formula z=(x−μ)/σ, where x is the post count associated with said social media account, μ is a population mean of posts on the social media platform where said social media account is hosted, and σ is a population standard deviation of posts on the social media platform where said social media account is hosted; (f) the computing system calculating the engagement rate for said social media account; (g) the computing system calculating a normalized engagement z-score using the formula z=(x−μ)/σ, where x is the engagement rate for said social media account, μ is a population mean of engagement rates across the social media platform where said social media account is hosted, and σ is a population standard deviation of engagement rates on the social media platform where said social media account is hosted; and (h) the computing system calculating the influencer score associated with said social media account by adding each of the follower z-score, post z-score and engagement z-score associated with said social media account together; whereby, the higher the influencer score is for a given social media account, the greater the influential effect said social media account has on other social media accounts on the social media platform where said social media account is hosted.

2. The method according to embodiment 1, further comprising the step of implementing a database in communication with the computing system and configured for selectively storing said data related to the at least one social media account.

3. The method according to embodiments 1-2, wherein each of the at least one influencer record further contains at least one of an influencer name associated with the social media account, an influencer type containing an at least one category label corresponding to the social media account, one or more additional influencer details associated with the social media account, and a topic table containing details related to any topics on which the associated social media account has posted about.

4. The method according to embodiments 1-3, wherein the step of the computing system calculating a normalized follower z-score for said social media account further comprises the step of, upon the computing system determining that the at least one analysis parameter is a comparison account, the computing system calculating each of the population mean and population standard deviation based on a follower count associated with said comparison account.

5. The method according to embodiments 1-4, wherein the step of the computing system calculating a normalized post z-score for said social media account further comprises the step of, upon the computing system determining that the at least one analysis parameter is a comparison account, the computing system calculating each of the population mean and population standard deviation based on a post count associated with said comparison account.

6. The method according to embodiments 1-5, wherein the step of the computing system calculating a normalized engagement z-score for said social media account further comprises the step of, upon the computing system determining that the at least one analysis parameter is a comparison account, the computing system calculating each of the population mean and population standard deviation based on the engagement rate of said comparison account.

7. The method according to embodiments 1-6, wherein the step of the computing system calculating a normalized follower z-score for said social media account further comprises the step of, upon the computing system determining that the at least one analysis parameter is a topic or keyword, the computing system calculating each of the population mean and population standard deviation based on a quantity of social media accounts on the social media platform where said social media account is hosted that are following or otherwise interacting with content related to said topic or keyword.

8. The method according to embodiments 1-7, wherein the step of the computing system calculating a normalized post z-score for said social media account further comprises the steps of, upon the computing system determining that the at least one analysis parameter is a topic or keyword: the computing system calculating the post count associated with said social media account based on a quantity of posts made by said social media account containing content related to said topic or keyword; and the computing system calculating each of the population mean and population standard deviation based on a quantity of posts made by social media accounts on the social media platform where said social media account is hosted containing content related to said topic or keyword.

9. The method according to embodiments 1-8, wherein the step of the computing system calculating a normalized engagement z-score for said social media account further comprises the step of, upon the computing system determining that the at least one analysis parameter is a topic or keyword, the computing system calculating each of the population mean and population standard deviation based on the engagement rates for posts made by social media accounts on the social media platform where said social media account is hosted containing content related to said topic or keyword.

10. The method according to embodiments 1-9, wherein the step of the computing system calculating a normalized follower z-score for said social media account further comprises the step of, upon the computing system determining that the at least one analysis parameter is a date range, the computing system calculating each of the population mean and population standard deviation based on a quantity of social media accounts on the social media platform where said social media account is hosted during said date range.

11. The method according to embodiments 1-10, wherein the step of the computing system calculating a normalized post z-score for said social media account further comprises the steps of, upon the computing system determining that the at least one analysis parameter is a date range: the computing system calculating the post count associated with said social media account based on a quantity of posts made by said social media account during said date range; and the computing system calculating each of the population mean and population standard deviation based on a quantity of posts made by social media accounts on the social media platform where said social media account is hosted during said date range.

12. The method according to embodiments 1-11, wherein the step of the computing system calculating a normalized engagement z-score for said social media account further comprises the step of, upon the computing system determining that the at least one analysis parameter is a date range, the computing system calculating each of the population mean and population standard deviation based on the engagement rates for posts made by social media accounts on the social media platform where said social media account is hosted during said date range.

13. The method according to embodiments 1-12, wherein the step of the computing system calculating the engagement rate for said social media account further comprises the steps of the computing system dividing a total number of relevant content interactions received by said social media account by the follower count associated with said social media account, and multiplying a resulting quotient by 100.

14. The method according to embodiments 1-13, wherein the step of the computing system calculating the engagement rate for said social media account further comprises the step of the computing system dividing a total number of content interactions received by said social media account by an estimated total reach of the posts made by said social media account.

15. The method according to embodiments 1-14, further comprising the step of the computing system calculating the total reach of the posts made by said social media account by multiplying the post count associated with said social media account by a pre-defined percentage of the follower count associated with said social media account.

16. The method according to embodiments 1-15, wherein the pre-defined percentage of the follower count associated with said social media account is 20%.

17. The method according to embodiments 1-16, further comprising the step of, upon the computing system determining a change in one or more of the follower count associated with said social media account, the post count associated with said social media account, the engagement rate associated with said social media account, the population mean of social media accounts on the social media platform where said social media account is hosted, the population standard deviation of social media accounts on the social media platform where said social media account is hosted, the population mean of posts on the social media platform where said social media account is hosted, the population standard deviation of posts on the social media platform where said social media account is hosted, the population mean of engagement rates across the social media platform where said social media account is hosted, or the population standard deviation of engagement rates on the social media platform where said social media account is hosted, the computing system repeating steps (a)-(h).

18. A non-transitory computer readable medium containing program instructions for causing an at least one computing device to perform a method of monitoring and quantifying a real-time influential effect of an at least one social media account hosted on an at least one social media platform, the method comprising the steps of: establishing an at least one influencer record associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account; and upon a user desiring to quantify the real-time influential effect of a one of the at least one social media account: (a) obtaining an at least one analysis parameter from said user, said at least one analysis parameter comprising at least one of a comparison account, a topic, a keyword, or a date range; (b) obtaining the follower count associated with said social media account; (c) calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted; (d) obtaining the post count associated with said social media account; (e) calculating a normalized post z-score for said social media account using the formula z=(x−μ)/σ, where x is the post count associated with said social media account, μ is a population mean of posts on the social media platform where said social media account is hosted, and σ is a population standard deviation of posts on the social media platform where said social media account is hosted; (f) calculating the engagement rate for said social media account; (g) calculating a normalized engagement z-score using the formula z=(x−μ)/σ, where x is the engagement rate for said social media account, μ is a population mean of engagement rates across the social media platform where said social media account is hosted, and σ is a population standard deviation of engagement rates on the social media platform where said social media account is hosted; and (h) calculating the influencer score associated with said social media account by adding each of the follower z-score, post z-score and engagement z-score associated with said social media account together; whereby, the higher the influencer score is for a given social media account, the greater the influential effect said social media account has on other social media accounts on the social media platform where said social media account is hosted.

19. The method according to embodiment 18, wherein each of the at least one influencer record further contains at least one of an influencer name associated with the social media account, an influencer type containing an at least one category label corresponding to the social media account, one or more additional influencer details associated with the social media account, and a topic table containing details related to any topics on which the associated social media account has posted about.

20. The method according to embodiments 18-19, wherein the step of calculating a normalized follower z-score for said social media account further comprises the step of, upon determining that the at least one analysis parameter is a comparison account, calculating each of the population mean and population standard deviation based on a follower count associated with said comparison account.

21. The method according to embodiments 18-20, wherein the step of calculating a normalized post z-score for said social media account further comprises the step of, upon determining that the at least one analysis parameter is a comparison account, calculating each of the population mean and population standard deviation based on a post count associated with said comparison account.

22. The method according to embodiments 18-21, wherein the step of calculating a normalized engagement z-score for said social media account further comprises the step of, upon determining that the at least one analysis parameter is a comparison account, calculating each of the population mean and population standard deviation based on the engagement rate of said comparison account.

23. The method according to embodiments 18-22, wherein the step of calculating a normalized follower z-score for said social media account further comprises the step of, upon determining that the at least one analysis parameter is a topic or keyword, calculating each of the population mean and population standard deviation based on a quantity of social media accounts on the social media platform where said social media account is hosted that are following or otherwise interacting with content related to said topic or keyword.

24. The method according to embodiments 18-23, wherein the step of calculating a normalized post z-score for said social media account further comprises the steps of, upon determining that the at least one analysis parameter is a topic or keyword: calculating the post count associated with said social media account based on a quantity of posts made by said social media account containing content related to said topic or keyword; and calculating each of the population mean and population standard deviation based on a quantity of posts made by social media accounts on the social media platform where said social media account is hosted containing content related to said topic or keyword.

25. The method according to embodiments 18-24, wherein the step of calculating a normalized engagement z-score for said social media account further comprises the step of, upon determining that the at least one analysis parameter is a topic or keyword, calculating each of the population mean and population standard deviation based on the engagement rates for posts made by social media accounts on the social media platform where said social media account is hosted containing content related to said topic or keyword.

26. The method according to embodiments 18-25, wherein the step of calculating a normalized follower z-score for said social media account further comprises the step of, upon determining that the at least one analysis parameter is a date range, calculating each of the population mean and population standard deviation based on a quantity of social media accounts on the social media platform where said social media account is hosted during said date range.

27. The method according to embodiments 18-26, wherein the step of calculating a normalized post z-score for said social media account further comprises the steps of, upon determining that the at least one analysis parameter is a date range: calculating the post count associated with said social media account based on a quantity of posts made by said social media account during said date range; and calculating each of the population mean and population standard deviation based on a quantity of posts made by social media accounts on the social media platform where said social media account is hosted during said date range.

28. The method according to embodiments 18-27, wherein the step of calculating a normalized engagement z-score for said social media account further comprises the step of, upon determining that the at least one analysis parameter is a date range, calculating each of the population mean and population standard deviation based on the engagement rates for posts made by social media accounts on the social media platform where said social media account is hosted during said date range.

29. The method according to embodiments 18-28, wherein the step of calculating the engagement rate for said social media account further comprises the steps of dividing a total number of relevant content interactions received by said social media account by the follower count associated with said social media account, and multiplying a resulting quotient by 100.

30. The method according to embodiments 18-29, wherein the step of calculating the engagement rate for said social media account further comprises the step of dividing a total number of content interactions received by said social media account by an estimated total reach of the posts made by said social media account.

31. The method according to embodiments 18-30, further comprising the step of calculating the total reach of the posts made by said social media account by multiplying the post count associated with said social media account by a pre-defined percentage of the follower count associated with said social media account.

32. The method according to embodiments 18-31, wherein the pre-defined percentage of the follower count associated with said social media account is 20%.

33. The method according to embodiments 18-32, further comprising the step of, upon determining a change in one or more of the follower count associated with said social media account, the post count associated with said social media account, the engagement rate associated with said social media account, the population mean of social media accounts on the social media platform where said social media account is hosted, the population standard deviation of social media accounts on the social media platform where said social media account is hosted, the population mean of posts on the social media platform where said social media account is hosted, the population standard deviation of posts on the social media platform where said social media account is hosted, the population mean of engagement rates across the social media platform where said social media account is hosted, or the population standard deviation of engagement rates on the social media platform where said social media account is hosted, repeating steps (a)-(h).

34. An influence quantification system for monitoring and quantifying a real-time influential effect of an at least one social media account hosted on an at least one social media platform, the system comprising: a central computing system configured for receiving and processing data related to the at least one social media account; and an at least one influencer record associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account; and upon a user of the computing system desiring to quantify the real-time influential effect of a one of the at least one social media account via a computing device in communication with the computing system, the computing system is configured for: (a) obtaining an at least one analysis parameter from said user, said at least one analysis parameter comprising at least one of a comparison account, a topic, a keyword, or a date range; (b) obtaining the follower count associated with said social media account; (c) calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted; (d) obtaining the post count associated with said social media account; (e) calculating a normalized post z-score for said social media account using the formula z=(x−μ)/σ, where x is the post count associated with said social media account, μ is a population mean of posts on the social media platform where said social media account is hosted, and σ is a population standard deviation of posts on the social media platform where said social media account is hosted; (f) calculating the engagement rate for said social media account; (g) calculating a normalized engagement z-score using the formula z=(x−μ)/σ, where x is the engagement rate for said social media account, μ is a population mean of engagement rates across the social media platform where said social media account is hosted, and σ is a population standard deviation of engagement rates on the social media platform where said social media account is hosted; and (h) calculating the influencer score associated with said social media account by adding each of the follower z-score, post z-score and engagement z-score associated with said social media account together; whereby, the higher the influencer score is for a given social media account, the greater the influential effect said social media account has on other social media accounts on the social media platform where said social media account is hosted.

35. The influence quantification system according to embodiment 34, further comprising a database in communication with the computing system and configured for selectively storing said data related to the at least one social media account.

36. The influence quantification system according to embodiments 34-35, wherein each of the at least one influencer record further contains at least one of an influencer name associated with the social media account, an influencer type containing an at least one category label corresponding to the social media account, one or more additional influencer details associated with the social media account, and a topic table containing details related to any topics on which the associated social media account has posted about.

37. The influence quantification system according to embodiments 34-36, wherein while calculating a normalized follower z-score for said social media account, the computing system is further configured for, upon determining that the at least one analysis parameter is a comparison account, calculating each of the population mean and population standard deviation based on a follower count associated with said comparison account.

38. The influence quantification system according to embodiments 34-37, wherein while calculating a normalized post z-score for said social media account, the computing system is further configured for, upon determining that the at least one analysis parameter is a comparison account, calculating each of the population mean and population standard deviation based on a post count associated with said comparison account.

39. The influence quantification system according to embodiments 34-38, wherein while calculating a normalized engagement z-score for said social media account, the computing system is further configured for, upon determining that the at least one analysis parameter is a comparison account, calculating each of the population mean and population standard deviation based on the engagement rate of said comparison account.

40. The influence quantification system according to embodiments 34-39, wherein while calculating a normalized follower z-score for said social media account, the computing system is further configured for, upon determining that the at least one analysis parameter is a topic or keyword, calculating each of the population mean and population standard deviation based on a quantity of social media accounts on the social media platform where said social media account is hosted that are following or otherwise interacting with content related to said topic or keyword.

41. The influence quantification system according to embodiments 34-40, wherein while calculating a normalized post z-score for said social media account, the computing system is further configured for, upon determining that the at least one analysis parameter is a topic or keyword: calculating the post count associated with said social media account based on a quantity of posts made by said social media account containing content related to said topic or keyword; and calculating each of the population mean and population standard deviation based on a quantity of posts made by social media accounts on the social media platform where said social media account is hosted containing content related to said topic or keyword.

42. The influence quantification system according to embodiments 34-41, wherein while calculating a normalized engagement z-score for said social media account, the computing system is further configured for, upon determining that the at least one analysis parameter is a topic or keyword, calculating each of the population mean and population standard deviation based on the engagement rates for posts made by social media accounts on the social media platform where said social media account is hosted containing content related to said topic or keyword.

43. The influence quantification system according to embodiments 34-42, wherein while calculating a normalized follower z-score for said social media account, the computing system is further configured for, upon determining that the at least one analysis parameter is a date range, calculating each of the population mean and population standard deviation based on a quantity of social media accounts on the social media platform where said social media account is hosted during said date range.

44. The influence quantification system according to embodiments 34-43, wherein while calculating a normalized post z-score for said social media account, the computing system is further configured for, upon determining that the at least one analysis parameter is a date range: calculating the post count associated with said social media account based on a quantity of posts made by said social media account during said date range; and calculating each of the population mean and population standard deviation based on a quantity of posts made by social media accounts on the social media platform where said social media account is hosted during said date range.

45. The influence quantification system according to embodiments 34-44, wherein while calculating a normalized engagement z-score for said social media account, the computing system is further configured for, upon determining that the at least one analysis parameter is a date range, calculating each of the population mean and population standard deviation based on the engagement rates for posts made by social media accounts on the social media platform where said social media account is hosted during said date range.

46. The influence quantification system according to embodiments 34-45, wherein while calculating the engagement rate for said social media account, the computing system is further configured for dividing a total number of relevant content interactions received by said social media account by the follower count associated with said social media account, and multiplying a resulting quotient by 100.

47. The influence quantification system according to embodiments 34-46, wherein while calculating the engagement rate for said social media account, the computing system is further configured for dividing a total number of content interactions received by said social media account by an estimated total reach of the posts made by said social media account.

48. The influence quantification system according to embodiments 34-47, wherein the computing system is further configured for calculating the total reach of the posts made by said social media account by multiplying the post count associated with said social media account by a pre-defined percentage of the follower count associated with said social media account.

49. The influence quantification system according to embodiments 34-48, wherein the pre-defined percentage of the follower count associated with said social media account is 20%.

50. The influence quantification system according to embodiments 34-49, wherein the computing system is further configured for, upon determining a change in one or more of the follower count associated with said social media account, the post count associated with said social media account, the engagement rate associated with said social media account, the population mean of social media accounts on the social media platform where said social media account is hosted, the population standard deviation of social media accounts on the social media platform where said social media account is hosted, the population mean of posts on the social media platform where said social media account is hosted, the population standard deviation of posts on the social media platform where said social media account is hosted, the population mean of engagement rates across the social media platform where said social media account is hosted, or the population standard deviation of engagement rates on the social media platform where said social media account is hosted, repeating steps (a)-(h).

In closing, regarding the exemplary embodiments of the present invention as shown and described herein, it will be appreciated that an influence quantification system is disclosed and configured for automatically monitoring and quantifying the influential effect of social media accounts. Because the principles of the invention may be practiced in a number of configurations beyond those shown and described, it is to be understood that the invention is not in any way limited by the exemplary embodiments, but is generally directed to an influence quantification system and is able to take numerous forms to do so without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the terms “about” and “approximately.” As used herein, the terms “about” and “approximately” mean that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the logic code, programs, modules, processes, methods, and the order in which the respective elements of each method are performed are purely exemplary. Depending on the implementation, they may be performed in any order or in parallel, unless indicated otherwise in the present disclosure. Further, the logic code is not related, or limited to any particular programming language, and may comprise one or more modules that execute on one or more processors in a distributed, non-distributed, or multiprocessing environment. Additionally, the various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The phrase “non-transitory,” in addition to having its ordinary meaning, as used in this document means “enduring or long-lived.” The phrase “non-transitory computer readable medium,” in addition to having its ordinary meaning, includes any and all computer readable mediums, with the sole exception of a transitory, propagating signal. This includes, by way of example and not limitation, non-transitory computer-readable mediums such as register memory, processor cache and random-access memory (“RAM”).

The methods as described above may be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multi-chip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A method for monitoring and quantifying a real-time influential effect of an at least one social media account hosted on an at least one social media platform, the method comprising the steps of:
implementing a central computing system configured for receiving and processing data related to the at least one social media account;
establishing, via the computing system, an at least one influencer record associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account; and
upon a user of the computing system desiring to quantify the real-time influential effect of a one of the at least one social media account via a computing device in communication with the computing system:
(a) the computing system obtaining an at least one analysis parameter from said user, said at least one analysis parameter comprising at least one of a comparison account, a topic, a keyword, or a date range;
(b) the computing system obtaining the follower count associated with said social media account;
(c) the computing system calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted;
(d) the computing system obtaining the post count associated with said social media account;
(e) the computing system calculating a normalized post z-score for said social media account using the formula z=(x−μ)/σ, where x is the post count associated with said social media account, μ is a population mean of posts on the social media platform where said social media account is hosted, and σ is a population standard deviation of posts on the social media platform where said social media account is hosted;
(f) the computing system calculating the engagement rate for said social media account;
(g) the computing system calculating a normalized engagement z-score using the formula z=(x−μ)/σ, where x is the engagement rate for said social media account, μ is a population mean of engagement rates across the social media platform where said social media account is hosted, and σ is a population standard deviation of engagement rates on the social media platform where said social media account is hosted; and
(h) the computing system calculating the influencer score associated with said social media account by adding each of the follower z-score, post z-score and engagement z-score associated with said social media account together;
whereby, the higher the influencer score is for a given social media account, the greater the influential effect said social media account has on other social media accounts on the social media platform where said social media account is hosted.

2. The method of claim 1, further comprising the step of implementing a database in communication with the computing system and configured for selectively storing said data related to the at least one social media account.

3. The method of claim 1, wherein each of the at least one influencer record further contains at least one of an influencer name associated with the social media account, an influencer type containing an at least one category label corresponding to the social media account, one or more additional influencer details associated with the social media account, and a topic table containing details related to any topics on which the associated social media account has posted about.

4. The method of claim 1, wherein the step of the computing system calculating a normalized follower z-score for said social media account further comprises the step of, upon the computing system determining that the at least one analysis parameter is a comparison account, the computing system calculating each of the population mean and population standard deviation based on a follower count associated with said comparison account.

5. The method of claim 4, wherein the step of the computing system calculating a normalized post z-score for said social media account further comprises the step of, upon the computing system determining that the at least one analysis parameter is a comparison account, the computing system calculating each of the population mean and population standard deviation based on a post count associated with said comparison account.

6. The method of claim 5, wherein the step of the computing system calculating a normalized engagement z-score for said social media account further comprises the step of, upon the computing system determining that the at least one analysis parameter is a comparison account, the computing system calculating each of the population mean and population standard deviation based on the engagement rate of said comparison account.

7. The method of claim 1, wherein the step of the computing system calculating a normalized follower z-score for said social media account further comprises the step of, upon the computing system determining that the at least one analysis parameter is a topic or keyword, the computing system calculating each of the population mean and population standard deviation based on a quantity of social media accounts on the social media platform where said social media account is hosted that are following or otherwise interacting with content related to said topic or keyword.

8. The method of claim 7, wherein the step of the computing system calculating a normalized post z-score for said social media account further comprises the steps of, upon the computing system determining that the at least one analysis parameter is a topic or keyword:
the computing system calculating the post count associated with said social media account based on a quantity of posts made by said social media account containing content related to said topic or keyword; and
the computing system calculating each of the population mean and population standard deviation based on a quantity of posts made by social media accounts on the social media platform where said social media account is hosted containing content related to said topic or keyword.

9. The method of claim 8, wherein the step of the computing system calculating a normalized engagement z-score for said social media account further comprises the step of, upon the computing system determining that the at least one analysis parameter is a topic or keyword, the computing system calculating each of the population mean and population standard deviation based on the engagement rates for posts made by social media accounts on the social media platform where said social media account is hosted containing content related to said topic or keyword.

10. The method of claim 1, wherein the step of the computing system calculating a normalized follower z-score for said social media account further comprises the step of, upon the computing system determining that the at least one analysis parameter is a date range, the computing system calculating each of the population mean and population standard deviation based on a quantity of social media accounts on the social media platform where said social media account is hosted during said date range.

11. The method of claim 10, wherein the step of the computing system calculating a normalized post z-score for said social media account further comprises the steps of, upon the computing system determining that the at least one analysis parameter is a date range:
the computing system calculating the post count associated with said social media account based on a quantity of posts made by said social media account during said date range; and
the computing system calculating each of the population mean and population standard deviation based on a quantity of posts made by social media accounts on the social media platform where said social media account is hosted during said date range.

12. The method of claim 11, wherein the step of the computing system calculating a normalized engagement z-score for said social media account further comprises the step of, upon the computing system determining that the at least one analysis parameter is a date range, the computing system calculating each of the population mean and population standard deviation based on the engagement rates for posts made by social media accounts on the social media platform where said social media account is hosted during said date range.

13. The method of claim 1, wherein the step of the computing system calculating the engagement rate for said social media account further comprises the steps of the computing system dividing a total number of relevant content interactions received by said social media account by the follower count associated with said social media account, and multiplying a resulting quotient by 100.

14. The method of claim 1, wherein the step of the computing system calculating the engagement rate for said social media account further comprises the step of the computing system dividing a total number of content interactions received by said social media account by an estimated total reach of the posts made by said social media account.

15. The method of claim 14, further comprising the step of the computing system calculating the total reach of the posts made by said social media account by multiplying the post count associated with said social media account by a pre-defined percentage of the follower count associated with said social media account.

16. The method of claim 15, wherein the pre-defined percentage of the follower count associated with said social media account is 20%.

17. The method of claim 1, further comprising the step of, upon the computing system determining a change in one or more of the follower count associated with said social media account, the post count associated with said social media account, the engagement rate associated with said social media account, the population mean of social media accounts on the social media platform where said social media account is hosted, the population standard deviation of social media accounts on the social media platform where said social media account is hosted, the population mean of posts on the social media platform where said social media account is hosted, the population standard deviation of posts on the social media platform where said social media account is hosted, the population mean of engagement rates across the social media platform where said social media account is hosted, or the population standard deviation of engagement rates on the social media platform where said social media account is hosted, the computing system repeating steps (a)-(h).

18. A non-transitory computer readable medium containing program instructions for causing an at least one computing device to perform a method of monitoring and quantifying a real-time influential effect of an at least one social media account hosted on an at least one social media platform, the method comprising the steps of:
establishing an at least one influencer record associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account; and
upon a user desiring to quantify the real-time influential effect of a one of the at least one social media account:
(a) obtaining an at least one analysis parameter from said user, said at least one analysis parameter comprising at least one of a comparison account, a topic, a keyword, or a date range;
(b) obtaining the follower count associated with said social media account;
(c) calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted;
(d) obtaining the post count associated with said social media account;
(e) calculating a normalized post z-score for said social media account using the formula z=(x−μ)/σ, where x is the post count associated with said social media account, μ is a population mean of posts on the social media platform where said social media account is hosted, and σ is a population standard deviation of posts on the social media platform where said social media account is hosted;
(f) calculating the engagement rate for said social media account;
(g) calculating a normalized engagement z-score using the formula z=(x−μ)/σ, where x is the engagement rate for said social media account, μ is a population mean of engagement rates across the social media platform where said social media account is hosted, and σ is a population standard deviation of engagement rates on the social media platform where said social media account is hosted; and
(h) calculating the influencer score associated with said social media account by adding each of the follower z-score, post z-score and engagement z-score associated with said social media account together;
whereby, the higher the influencer score is for a given social media account, the greater the influential effect said social media account has on other social media accounts on the social media platform where said social media account is hosted.

19. An influence quantification system for monitoring and quantifying a real-time influential effect of an at least one social media account hosted on an at least one social media platform, the system comprising:
a central computing system configured for receiving and processing data related to the at least one social media account; and
an at least one influencer record associated with each of the at least one social media account, each of the at least one influencer record containing at least one of a unique record identifier, a post count containing a numerical value corresponding to a quantity of discrete content posts made by the associated social media account, a follower count containing a numerical value corresponding to a quantity of followers of the associated social media account, a numerical engagement rate, and an influencer score containing a numerical value corresponding to the relative effectiveness of the associated social media account; and
upon a user of the computing system desiring to quantify the real-time influential effect of a one of the at least one social media account via a computing device in communication with the computing system, the computing system is configured for:
(a) obtaining an at least one analysis parameter from said user, said at least one analysis parameter comprising at least one of a comparison account, a topic, a keyword, or a date range;
(b) obtaining the follower count associated with said social media account;
(c) calculating a normalized follower z-score for said social media account using the formula z=(x−μ)/σ, where x is the follower count associated with said social media account, μ is a population mean of social media accounts on the social media platform where said social media account is hosted, and σ is a population standard deviation of social media accounts on the social media platform where said social media account is hosted;
(d) obtaining the post count associated with said social media account;
(e) calculating a normalized post z-score for said social media account using the formula z=(x−μ)/σ, where x is the post count associated with said social media account, μ is a population mean of posts on the social media platform where said social media account is hosted, and σ is a population standard deviation of posts on the social media platform where said social media account is hosted;
(f) calculating the engagement rate for said social media account;
(g) calculating a normalized engagement z-score using the formula z=(x−μ)/σ, where x is the engagement rate for said social media account, μ is a population mean of engagement rates across the social media platform where said social media account is hosted, and σ is a population standard deviation of engagement rates on the social media platform where said social media account is hosted; and
(h) calculating the influencer score associated with said social media account by adding each of the follower z-score, post z-score and engagement z-score associated with said social media account together;
whereby, the higher the influencer score is for a given social media account, the greater the influential effect said social media account has on other social media accounts on the social media platform where said social media account is hosted.

20. The influence quantification system of claim 19, further comprising a database in communication with the computing system and configured for selectively storing said data related to the at least one social media account.
